(19) United States
(12) Patent Application Publication
(10) Pub. No.: US 2007/0170868 A1
(43) Pub. Date: Jul. 26, 2007

(54) Power tool having an illuminating device

(76) Inventor: Shuming Wu, Nanjing City (CN)

Correspondence Address: MCDERMOTT, WILL & EMERY LLP, 227 WEST MONROE STREET, CHICAGO, IL, 60606-5096, US

(21) Appl. No.: 11/655,521

(22) Filed: Jan. 19, 2007

(30) Foreign Application Priority Data
Jan. 20, 2006 (CN) 200620068680.1

(51) Int. Cl. H05B 39/09

(52) U.S. Cl. 315/200 A

(57) ABSTRACT

The present invention provides a power tool with an integral light source, wherein the tool includes a housing having a power source, an enclosed motor, at least one light source, and, a power switch moveable between an on position and an off position. The housing further includes a light detector window and a control circuit, wherein the control circuit comprises at least one infrared detector. The light source is activated to provide light when the power switch is in the on position. When the power switch is released to an off position and the light detector window is covered such that a dark condition is detected by the control circuit, the light source continues to provide illumination. When the power switch is released to the off position and the light detector window is exposed to light as detected by the control circuit, the light source is turned off. Therefore, the light source and the motor can be turned on or off by a common switch, without manually and separately turning off the light source.

### CROSS-REFERENCE TO RELATED APPLICATIONS

This application claims priority to Chinese Application No. 200620068680.1 filed Jan. 20, 2006, the entire disclosure of which is incorporated herein by reference. Priority to this application is claimed under 35 U.S.C. 119, 120 and/or 365.

### FEDERALLY SPONSORED RESEARCH OR DEVELOPMENT

Not Applicable.

### TECHNICAL FIELD

The present invention relates to a power tool having an illuminating device that can be turned on and off without manual operation.

### BACKGROUND OF THE INVENTION

Power tools can be equipped with illuminating devices for facilitating operation under low light conditions. These power tool have an illuminating device that generally comprises a light control circuit electrically separate from the motor control circuit, i.e. the light can be turned on without switching on the motor. However, the power tool, including the illuminating device, is powered by a single rechargeable battery. If the illuminating device or light is left on after operation of the power tool, the light will continue to draw current from the rechargeable battery until the battery is discharged. Discharging the battery may permanently damage the battery.

German Patent No. DE3831344 discloses a power tool having an illuminating device, where the light control circuit and the motor control circuit are operable by a single two-stage push switch. When the switch is depressed to an intermediate position, the light control circuit closes thereby activating the light; while the motor control circuit remains open and the motor does not operate. If the two-stage switch is depressed further, the motor control circuit closes thereby permitting the motor to rotate. The light control circuit further includes a timer circuit that turns off the light after a predetermined period of time following the release of the switch and the opening of the light control circuit. Since the timer circuit automatically turns off the light, permanent damage to the battery resulting from forgetting to turn off the light is avoided. However, according to the German patent, the switch must be depressed to the intermediate position to keep the light on. Therefore, the operator must continue to depress the switch with his/her finger while using and/or adjusting the position of the power tool. Accordingly, it is uncomfortable and fatiguing for the operator if continuous or repeated operation is needed. Furthermore, manufacturing costs are increased because two-stage push switches are more expensive than other existing switches.

### SUMMARY OF THE INVENTION

The present invention provides an improved power tool having an illuminating device that provides light during operation and that does not require manual interaction to be turned off.

According to one aspect of the invention, the power tool comprises a housing, a power source, a motor enclosed within the housing, at least one light source, a power switch, a control circuit, and a light detector window, wherein the control circuit comprises at least one infrared detector.

When the power switch is in an off position and the light detector window is covered, such that a dark condition is detected by the control circuit, the light source remains operable to provide light. When the power switch is in the off position and the light detector window is exposed to light, the control circuit turns the light source to an off setting.

Compared to existing devices, the power tool of the present invention doe not require manual interaction to turn off the light source. As a result, permanent damage to the battery resulting from not turning off the light source is avoided. Furthermore, the light source and the motor can be easily turned on or off by a common switch, without having to use a two-stage push switch.

### BRIEF DESCRIPTION OF THE DRAWINGS

FIG. 1 is a perspective view of a power tool according to a preferred embodiment of the present invention;

FIG. 2 is a schematic diagram of a control circuit for the power tool of FIG. 1.

### DETAILED DESCRIPTION

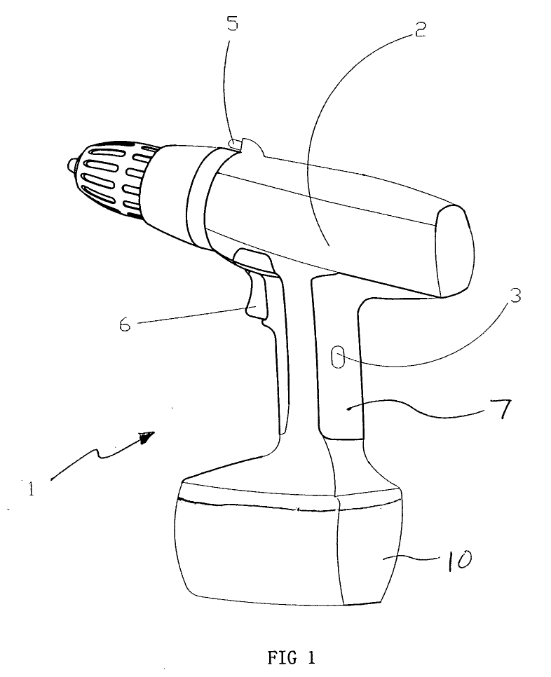

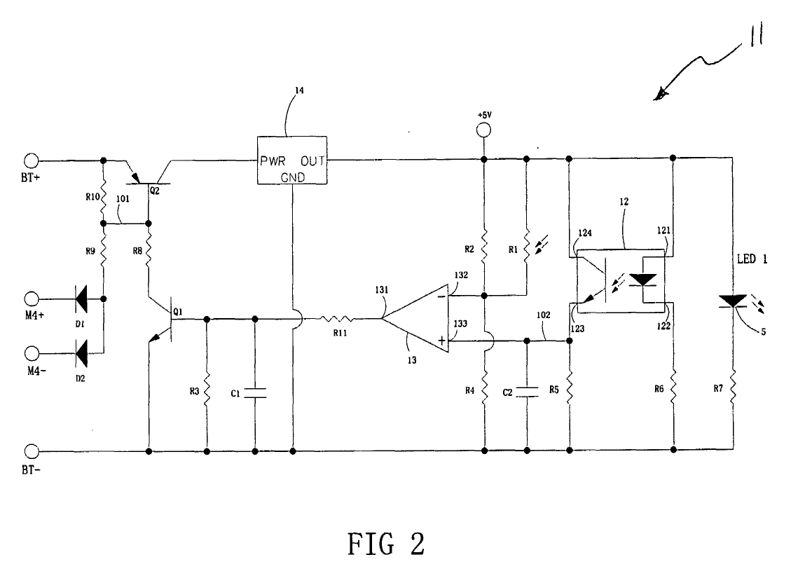

Referring to FIG. 1, in one of the embodiments of the present invention, a power tool 1, such as a hand-held drill, comprises a housing 2, a power source 10, a motor M4 (see FIG. 2) enclosed within the housing 2, at least one light source 5, a switch 6, a light detector window 3. As shown in FIG. 1, the light detector window 3 is disposed on or formed in a handle portion 7 of the housing 2, wherein an operator's hand may obstruct or cover the window 3 while grasping the handle 7 to actuate the switch 6. In this embodiment, the power source 10 is a removable, rechargeable battery pack and the light source 5 is at least one light emitting diode (LED) (designated in FIG. 2 as LED 1). When the switch 6 is depressed, the motor M4 is activated and the light source 5 is simultaneously operated. In contrast, when the switch 6 is released, the motor M4 ceases operation but as explained below, the light source 5 may remain operable.

FIG. 2 is a schematic diagram of a control circuit 11 for the power tool 1. The control circuit 11 comprises a photosensitive resistor R1, and a retro-reflection infrared photoelectric sensor 12, and an operational amplifier 13, wherein the photosensitive resistor R1 is connected to one input 132 of the operational amplifier 13 and the retro-reflection infrared photoelectric sensor 12 is connected to the other input 133 of the operational amplifier 13. In this embodiment, the photosensitive resistor R1 and the resistor R2 are in parallel with each other and connected to a cathode BT− of the battery via a resistor R4, wherein the connection point of the resistor R4 and the resistors R1 and R2 acts as the input 132. An electrical contact 123 of the retro-reflection infrared photoelectric sensor 12 is connected to the BT− through a capacitor C2 and a resistor R5 in parallel connection with each other, wherein the connection point of the electrical contact 123, the capacitor C2 and the resistor R5 acts as the input 133. Meanwhile, an electrical contact 122 is connected to BT− via a resistor R6. The control circuit 11 can be constructed as another arrangement, and not limited to the present circuit construction as described hereinabove and illustrated in the drawing. When an input voltage on the input 132 is higher than an input voltage on the input 133, the output 131 of the operational amplifier 13 outputs a low-level voltage. In contrast, when an input voltage on the input 132 is lower than an input voltage on the input 133, the output 131 of the operational amplifier 13 outputs a high-level voltage. The output 131 of the operational amplifier 13 connects to a base of a NPN transistor Q1 via a resistor R11 so that when the output 131 outputs a high-level voltage the NPN transistor Q1 is turned-on, and when the output 131 outputs a low-level voltage the NPN transistor Q1 is turned-off. A discharging circuit consisting of a resistor R3 and a capacitor C1 is connected to the base of the NPN transistor Q1 to ensure that when the output 131 outputs a low-level voltage, a base voltage of the NPN transistor Q1 will drop to low level as soon as possible. A collector of the NPN transistor Q1 is connected to a base of a PNP transistor Q2 through a resistor R8, while an emitter of the NPN transistor Q1 is connected to BT−.

An anode BT+ of the battery is connected to an emitter of the PNP transistor Q2 and a resistor R10. A resistor R9 is connected to a pair of switch diodes D1 and D2, at the same time, a connection point of the resistor R9 and R10 is connected to the base of the PNP transistor Q2. The switch diode D1 connects to an anode M4+ of the motor M4, while the switch diode D2 connects to a cathode M4− of the motor M4. Once the switch 6 is depressed, the motor M4 is powered on and the circuit 101 is turned-on. Consequently, the PNP transistor Q2 is turned-on, and an integrate voltage regulator 14 connected to an emitter of the PNP transistor Q2 outputs a voltage of +5V with an output of the regulator being connected to the photosensitive resistor RI, the resistor R2, electrical contacts 124 and 121 of the retro-reflection infrared photoelectric sensor 12 and the light emitting diode LED 1, wherein the light emitting diode LED1 is connected to BT− via a resistor R7, so that the light emitting diode LED1 is operating to provide light. If the detector window 3 is obstructed, such as when the operator grasps the handle 7, reflected infrared light is detected by the retro-reflection infrared photoelectric sensor 12 so as to turn on the retro-reflection infrared photoelectric sensor 12 whereby current flows through the circuit 102. The resistance of the photosensitive resistor R1 is enhanced such that the input voltage on the input 132 is lower than that on the input 133. Thus, the operational amplifier 13 outputs the high-level voltage and the NPN transistor Q1 is then turned-on. If the switch 6 is released, the PNP transistor Q2 connected to the NPN transistor Q1 is turned-on and thus the integrate voltage regulator 14 outputs the voltage of +5V whereby the light emitting diode LED1 remains operational to provide light.

If the detector window 3 is not obstructed when the switch 6 is released, no reflected infrared light can be detected by the retro-reflection infrared photoelectric sensor 12 and the resistance of the photosensitive resistor R1 decreases due to brighter environment light. As a result, the input voltage on the input 132 is higher than that on the input 133 so that the operational amplifier 13 outputs the low-level voltage. Thus, the NPN transistor Q1 is cut-off and the PNP transistor Q2 connected to the NPN transistor Q1 is cut-off too, with a result that the control circuit 11 automatically shuts off and the light emitting diode LED1 is then turned off.

When the power tool 1 is operated in sunlight or bright light conditions, even if the detector window 3 is not obstructed, there still exists reflected infrared light which can be detected by the retro-reflection infrared photoelectric sensor 12. So, a small amount of current exists thereof and flows in the circuit 102. However, the resistance of the photosensitive resistor R1 decreases to a very low owing to the sunlight or bright light conditions such that the NPN transistor Q1 is thus turned-off. That is, after the switch 6 is released, the PNP transistor Q2 connected to the NPN transistor Q 1 is then turned-off and the control circuit 11 automatically shuts off with a result that the light emitting diode LED1 is turned off.

According to the present invention, when an operator holds the handle 7 of the power tool 1, the operator's hand obstructs the detector window 3 and presses the switch 6 at the same time, the motor M4 begins to operate and the light emitting diode LED1 simultaneously provides light. If the user releases the switch 6 but remains holding the handle 7, the control circuit 11 recognizes that the detector window 3 is obstructed and the light emitting diode LED1 remains operational to provide light. Otherwise, when the operator's hand disengages the handle 7 and exposes the detector window 3, the control circuit 11 automatically shuts off so that the light emitting diode LED1 ceases operation.

In the present embodiment, the parameters of several units and elements in the control circuit are listed as below:
Diodes D1, D2: IN4148
Retro-reflection infrared photoelectric sensor 12: RG149A
Operational amplifier 13: LM358
Integrate voltage regulator 14: LM38L05

The present invention is not intended to be limited to the above-mentioned embodiment. It is easily understood for those ordinary skilled in the art that there are also various modifications or alternatives without departing the conception and principle of the present invention. The scope of the present invention is defined by the appended claims.

What is claimed is:

1. A power tool having an illuminating device, comprising:
a housing having a power source, an enclosed motor, at least one light source, and, a power switch moveable between an on position and an off position;
the housing further having a light detector window and a control circuit, wherein the control circuit comprises at least one infrared detector; and,
wherein the at least one light source being activated to provide light when the power switch is in the on position.

2. The power tool of claim 1, wherein the power source comprises at least one battery pack.

3. The power tool of claim 1, wherein the at least one infrared detector comprises a retro-reflection infrared photoelectric sensor.

4. The power tool of claim 3, wherein the control circuit comprises a photosensitive resistor.

5. The power tool of claim 4, the control circuit further comprising an operational amplifier having a first input connected to the photosensitive resistor and a second input connected to the retro-reflection infrared photoelectric sensor.

6. The power tool of claim 1, wherein the at least one light source comprises a light emitting diode.

7. The power tool of claim 1, wherein when the power switch is moved to the off position and the light detector window is obstructed such that a dark condition is detected by the control circuit, the at least one light source remains operational to provide light.

8. The power tool of claim 7, wherein when the power switch is moved to the off position and the light detector window is exposed to light, the at least one light source ceases operation.

9. The power tool of claim 1, wherein the light detector window is disposed on a handle of the housing.

10. A power tool having an illuminating device, comprising:
a housing having a power source and a switch moveable between an on position and an off position;
a motor enclosed within the housing, the motor being operable when the power switch is in the on position and un-operable when the power switch is in the off position;
the housing further having at least one light source, a control circuit having at least one retro-reflection photoelectric detector, and a light detector window;
wherein when the power switch is in the on position and light detector window is obstructed, the light source provides light;
wherein when the power switch is moved from the on position to the off position and the light detector window is obstructed, the light source continues to provide light; and,
wherein when the power switch is moved from the on position to the off position and the light detector window is exposed to light, the light source ceases to provide light.

11. The power tool of claim 10, wherein the at least one retro-reflection photoelectric detector is at least one retro-reflection infrared photoelectric sensor.

12. The power tool of claim 11, wherein the control circuit comprises a photosensitive resistor.

13. The power tool of claim 12, wherein the control circuit further comprises an operational amplifier having a first input connected to the photosensitive resistor and a second input connected to the retro-reflection infrared photoelectric sensor.

14. The power tool of claim 13, wherein the control circuit further comprises a NPN transistor connected to an output of the amplifier.

15. The power tool of claim 10, wherein the housing includes a handle and the light detector window is disposed on the handle.

16. The power tool of claim 15, wherein the switch is located in a front portion of the handle and the light detector window is located in a rear portion of the handle.

17. The power tool of claim 10, wherein the power source comprises a rechargeable battery removably connectable to the housing.

18. The power tool of claim 14, wherein the light source comprises a light emitting diode.

19. A method of using a power tool to perform operations to a first work object and a second work object, the method comprising the following steps:
providing a power tool comprising a housing with a handle, an enclosed motor, at least one light source, a power switch, a light detector window, a retro-reflection photoelectric detector disposed adjacent to the light detector window;
grasping the handle while covering the light detector window;
depressing the power switch to activate operation of both the motor and the light source;
performing an operation to the first work object;
releasing the power switch while covering the light detector window, whereby operation of the motor ceases and the light source remains in operation;
locating the second work object by illuminating the second work object with the light source;
depressing the power switch to activate operation of the motor; and,
performing an operation to the second work object.

20. The method of claim 19, further comprising steps of:
releasing the power switch and exposing the light detector window, whereby the operation of both the motor and the light sources ceases.
